(19) United States
(12) Patent Application Publication
(10) Pub. No.: US 2023/0125422 A1
(43) Pub. Date: Apr. 27, 2023

(54) CONTROL APPARATUS AND CONTROL METHOD AS WELL AS COMPUTER PROGRAM

(71) Applicant: SONY GROUP CORPORATION, TOKYO (JP)

(72) Inventor: RYOICHI TSUZAKI, TOKYO (JP)

(21) Appl. No.: 17/906,393

(22) PCT Filed: Jan. 26, 2021
(86) PCT No.: PCT/JP2021/002611

§ 371 Date: Sep. 15, 2022

(30) Foreign Application Priority Data
Mar. 23, 2020 (JP) 2020-051892

(51) Int. Cl. B25J 9/16; G05B 19/4155

(52) U.S. Cl. CPC B25J 9/1602; G05B 19/4155; G05B 2219/50391

(57) ABSTRACT

Control for controlling a robot that allows selection from among multiple gaits is provided. The control apparatus includes a cost map creation unit that creates a cost map for each of gaits of the robot that allows selection from among multiple gaits, and a path creation unit that creates a path including gait switching for the robot by using the cost maps created by the cost map creation unit. The path creation unit searches for the shortest path by using the cost map of the gait that is high in traversing performance among the multiple gaits, performs search for a gait switching point on the path found out, and researches, in a case where there is a gait switching point, for a path on the cost map of the gait selected by an objective function, by using the gait switching point as a sub goal.

### TECHNICAL FIELD

The technology disclosed in the present specification (hereinafter referred to as the “present disclosure”) relates to a control apparatus and a control method as well as a computer program for controlling a robot.

### BACKGROUND ART

In recent years, mobile robots are under development and are on the verge of being widely used in various fields. Automated mobile robots are used for transportation of luggage and so forth. Mobile robots can be classified by mechanism into a leg type, a wheel type, a crawler type, an articulated body type, and so forth. For example, a mobile robot of the complex type that includes multiple movement mechanisms such as legs and wheels has been proposed (refer to PTL 1).

In a robot that allows selection between multiple gaits by legs and wheels, for movement of the robot, it is desired to select, on a level ground, the gait that uses the wheels and is low in speed but select, on a stepped or uneven place, the gait that uses the legs and is high in traversing performance. Further, upon movement, it is necessary to avoid a dynamic obstacle, and hence, also fast response is important. Accordingly, it is necessary to create a path in which the robot can advance while the gait of the robot is switched on a real time basis with use of limited computation resources.

For example, there has been proposed a walking robot apparatus in which the gait is changed according to a situation of the road surface and a current posture of the robot (refer to PTL 2). Since this walking robot apparatus is equipped only with one type of legs as its movement mechanism, the gait is switched only between crawl walking and trot walking, and switching between movement mechanisms is not performed.

Further, there has been proposed a path creation method for a mobile robot to create a path along which the robot is to travel from a visual point to an end point while avoiding obstacles (refer to PTL 3). However, this method involves difficulty in coping with avoidance of a dynamic obstacle and does not create a path taking switching between movement mechanisms into consideration.

### CITATION LIST

### Patent Literature

### [PTL 1]

Japanese Patent Laid-Open No. 2014-161991

### [PTL 2]

Japanese Patent Laid-Open No. 2006-255798

### [PTL 3]

Japanese Patent Laid-Open No. Hei10-333746

### SUMMARY

### Technical Problem

It is an object of the present disclosure to provide a control apparatus and a control method as well as a computer program for controlling a robot that allows selection from among multiple gaits.

### Solution to Problem

The present disclosure has been made taking the problem described above into consideration, and a first aspect of the present disclosure is a control apparatus for a robot, including a cost map creation unit that creates a cost map for each of gaits of the robot that allows selection from among multiple gaits, and a path creation unit that creates a path including gait switching for the robot by using the cost maps created by the cost map creation unit.

The path creation unit searches for the shortest path by using the cost map of the gait that is high in traversing performance and that is among the multiple gaits, performs search for a gait switching point on the searched out path, and re-searches, in a case where there is a gait switching point, for a path on the cost map of the gait selected by an objective function, by using the gait switching point as a sub goal.

The control apparatus may be configured such that, when an instruction relating to carrying out of a gait including gait switching is to be given to the robot in reference to the cost maps created by the path creation unit, an instruction regarding a transition time period for gait switching may be given together to the robot.

Meanwhile, the second aspect of the present disclosure is a control method for a robot, including a cost map creation step of creating a cost map for each of gaits of the robot that allows selection from among multiple gaits, and a path creation step of creating a path including gait switching for the robot by using the cost maps created in the cost map creation step.

Further, the third aspect of the present disclosure is a computer program described in a computer-readable form, the computer program causing a computer to function as a cost map creation unit that creates a cost map for each of gaits of the robot that allows selection from among multiple gaits, and a path creation unit that creates a path including gait switching for the robot by using the cost maps created by the cost map creation unit.

The computer program according to the third aspect of the present disclosure defines a computer program that is described in a computer-readable form such that it implements a predetermined process on a computer. In other words, by installing the computer program according to the third aspect of the present disclosure into a computer, cooperative action is demonstrated on the computer, and advantageous working-effects similar to those of the control apparatus according to the first aspect of the present disclosure can be achieved.

### Advantageous Effect of Invention

According to the present disclosure, a control apparatus and a control method as well as a computer program for a robot for performing path creation including switching of the gait of a robot that allows selection from among multiple gaits can be provided.

It is to be noted that the advantageous effect described in the present specification is exemplary to the last, and the advantageous effects brought about by the present disclosure are not limited to it. Further, the present disclosure sometimes demonstrates further additional advantageous effects in addition to the advantageous effect described above.

Further objects, features, and advantages of the present disclosure will become apparent from more detailed description based on the embodiment hereinafter described and the accompanying drawings.

### BRIEF DESCRIPTION OF DRAWINGS

FIG. 1 is a view depicting an example of a configuration of a robot apparatus 100.

FIG. 2 is a view depicting an example of a configuration of a robot apparatus 200.

FIG. 3 is a view depicting an example of a configuration of a control system 300 for the robot apparatus 100.

FIG. 4 is a view depicting an example of a functional configuration for performing path creation for the robot apparatus 100.

FIG. 5 is a flow chart depicting a processing procedure for performing path creation for the robot apparatus 100.

FIG. 6 is a diagram depicting an example of a leg cost map.

FIG. 7 is a diagram depicting an example of a wheel cost map.

FIG. 8 is a diagram depicting a path created on the leg cost map for the robot apparatus 100.

FIG. 9 is a diagram depicting, on the wheel cost map, a gait switching point searched out on the path for the robot apparatus 100.

FIG. 10 is a diagram depicting an example in which a gait switching point is searched for with the width of the robot apparatus 100 taken into consideration.

FIG. 11 is a diagram depicting the example in which a gait switching point is searched for with the width of the robot apparatus 100 taken into consideration.

FIG. 12 is a diagram depicting the example in which a gait switching point is searched for with the width of the robot apparatus 100 taken into consideration.

FIG. 13 is a diagram depicting the example in which a gait switching point is searched for with the width of the robot apparatus 100 taken into consideration.

FIG. 14 is a diagram depicting the example in which a gait switching point is searched for with the width of the robot apparatus 100 taken into consideration.

FIG. 15 is a diagram depicting an example in which gait switching is performed with a physical property of the robot apparatus 100 taken into consideration.

FIG. 16 is a diagram depicting the example in which gait switching is performed with the physical property of the robot apparatus 100 taken into consideration.

FIG. 17 is a diagram depicting the example in which gait switching is performed with the physical property of the robot apparatus 100 taken into consideration.

FIG. 18 is a diagram depicting the example in which gait switching is performed with the physical property of the robot apparatus 100 taken into consideration.

FIG. 19 is a diagram depicting the example in which gait switching is performed with the physical property of the robot apparatus 100 taken into consideration.

FIG. 20 is a diagram depicting the example in which gait switching is performed with the physical property of the robot apparatus 100 taken into consideration.

FIG. 21 is a diagram depicting another example in which gait switching is performed with the physical property of the robot apparatus 100 taken into consideration.

FIG. 22 is a diagram depicting the other example in which gait switching is performed with the physical property of the robot apparatus 100 taken into consideration.

FIG. 23 is a diagram depicting the other example in which gait switching is performed with the physical property of the robot apparatus 100 taken into consideration.

FIG. 24 is a diagram depicting the other example in which gait switching is performed with the physical property of the robot apparatus 100 taken into consideration.

FIG. 25 is a diagram depicting a further example in which gait switching is performed with the physical property of the robot apparatus 100 taken into consideration.

FIG. 26 is a diagram depicting the example in which gait switching is performed with the physical property of the robot apparatus 100 taken into consideration.

FIG. 27 is a diagram depicting the example in which gait switching is performed with the physical property of the robot apparatus 100 taken into consideration.

FIG. 28 is a diagram depicting the example in which gait switching is performed with the physical property of the robot apparatus 100 taken into consideration.

FIG. 29 is a diagram depicting the example in which gait switching is performed with the physical property of the robot apparatus 100 taken into consideration.

FIG. 30 is a diagram depicting an example of a functional configuration for performing path creation for the robot apparatus 100.

### DESCRIPTION OF EMBODIMENT

In the following, the technology according to the present disclosure is described in the order given below, with reference to the drawings.

A. Appearance Configuration

B. Configuration of Control System

C. Functional Configuration for Path Creation

D. Path Creation Procedure

E. Specific Example of Path Creation

F. Modification of Path Creation Procedure

G. Characteristics and Advantageous Effects of Present Disclosure

### A. Appearance Configuration

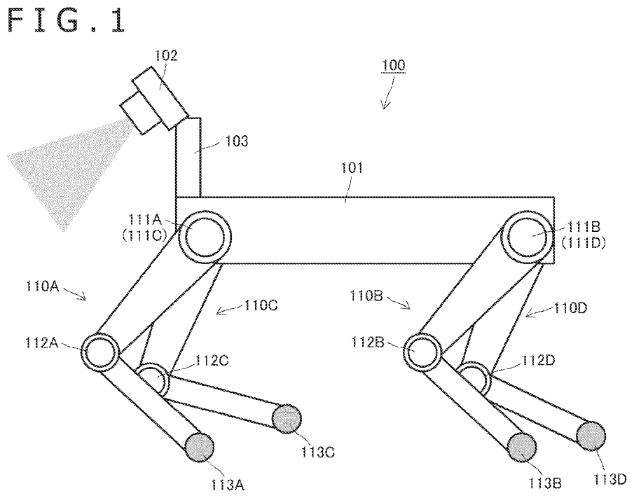

FIG. 1 schematically depicts an example of a configuration of a robot apparatus 100 to which the present disclosure is applied. The robot apparatus 100 includes a body unit 101, a visual sensor 102, a joint unit 103, and four legs of leg units 110A to 110D.

The visual sensor 102 is a sensor that visually recognizes an environment around the robot apparatus 100 and includes at least one of, for example, a camera (including a stereo camera), an infrared camera, a TOF (Time Of Flight) sensor, a LiDAR, and so forth. The visual sensor 102 is attached to the body unit 101 through the joint unit 103 for moving the gaze direction of the visual sensor 102 upwardly, downwardly, leftwardly, or rightwardly. Further, the robot apparatus 100 may include sensors other than the visual sensor 102, such as an IMU (Inertial Measurement Unit) mounted on the body unit 101 and the leg units 110A to 110D, a grounding sensor on the sole of the leg units 110A to 110D or a tactile sensor on the surface of the body unit 101.

The leg units 110A to 110D as moving means are connected to the body unit 101 through joint units 111A to 111D that each correspond to the hip joints. The leg units 110A to 110D respectively include joint units 112A to 112D that each connect a thigh link and a lower leg link to each other and wheel units 113A to 113D at a distal end of the lower leg link (or at the sole). Accordingly, the robot apparatus 100 is a four-legged robot that allows selection between two kinds of gaits of the leg gait (walking) and the wheel gait. The gaits provided for the robot apparatus 100 are different in traversing performance and moving speed.

The joint units 111A to 111D and the joint units 112A to 112D each have at least a degree of freedom around the pitch. The joint units 111A to 111D and the joint units 112A to 112D each include a motor for driving the joint, an encoder for detecting the position of the motor, and a torque sensor for detecting torque of the output power shaft side of the motor (none of them is depicted). It is to be noted, however, that the torque sensor is not an essential component for implementing the present disclosure.

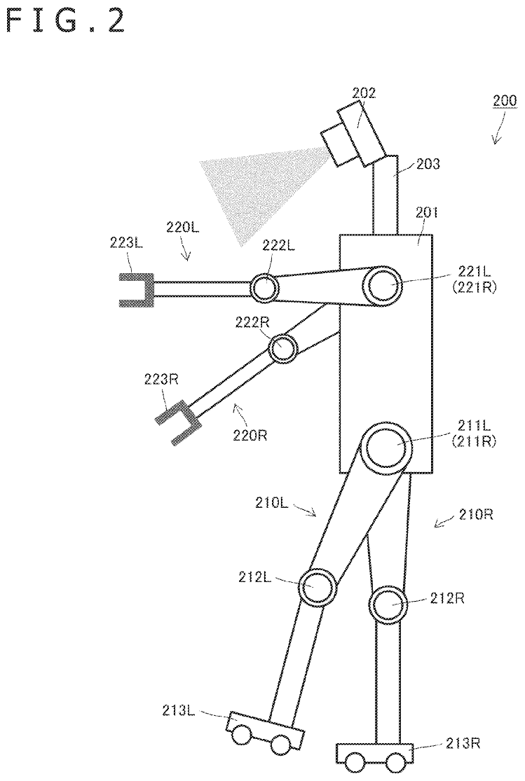

Meanwhile, FIG. 2 schematically depicts an example of a configuration of a robot apparatus 200 to which the present disclosure is applied. The robot apparatus 200 includes a body unit 201, a visual sensor 202, a joint unit 203, two legs including a right leg unit 210R and a left leg unit 210L, and a right arm unit 220R and a left arm unit 220L.

The visual sensor 202 is a sensor that visually recognizes an environment around the robot apparatus 200 and includes at least one of a camera (including a stereo camera), an infrared camera, a TOF sensor, a LiDAR, and so forth. The visual sensor 202 is attached to the body unit 201 through the joint unit 203 for moving the gaze direction of the visual sensor 202 upwardly, downwardly, leftwardly, and rightwardly.

The right leg unit 210R and the left leg unit 210L as moving means are connected to lower ends of the body unit 201 through joint units 211R and 211L that each correspond to the hip joints. The right leg unit 210R and the left leg unit 210L each include joint units 212R and 212L each of which corresponds to the knee joint that connects a thigh link and a lower leg link to each other, and grounding units (or foot units) 213R and 213L at a distal end of the lower leg links. The grounding units 213R and 213L have wheel units. Accordingly, the robot apparatus 200 is a two-legged robot that allows selection between two kinds of gaits including the leg gait and the wheel gait.

The right arm unit 220R and the left arm unit 220L are connected to portions near an upper end of the body unit 201 through joint units 221R and 221L that each correspond to the shoulder joints. The right arm unit 220R and the left arm unit 220L each include a joint unit 222R or 222L that corresponds to the elbow joint that connects an upper arm link and a front arm link to each other, and a hand unit (or gripping unit) 223R or 223L at a distal end of the front arm links.

The joint units 211R and 211L, the joint units 212R and 212L, the joint units 221R and 221L, and the joint units 222R and 222L each include a motor for driving the joint, an encoder for detecting the position of the motor, a speed reducer, and a torque sensor for detecting the torque on the output power shaft side of the motor (none of them is depicted). It is to be noted, however, that the torque sensor is not an essential component for implementing the present disclosure.

### B. Configuration of Control System

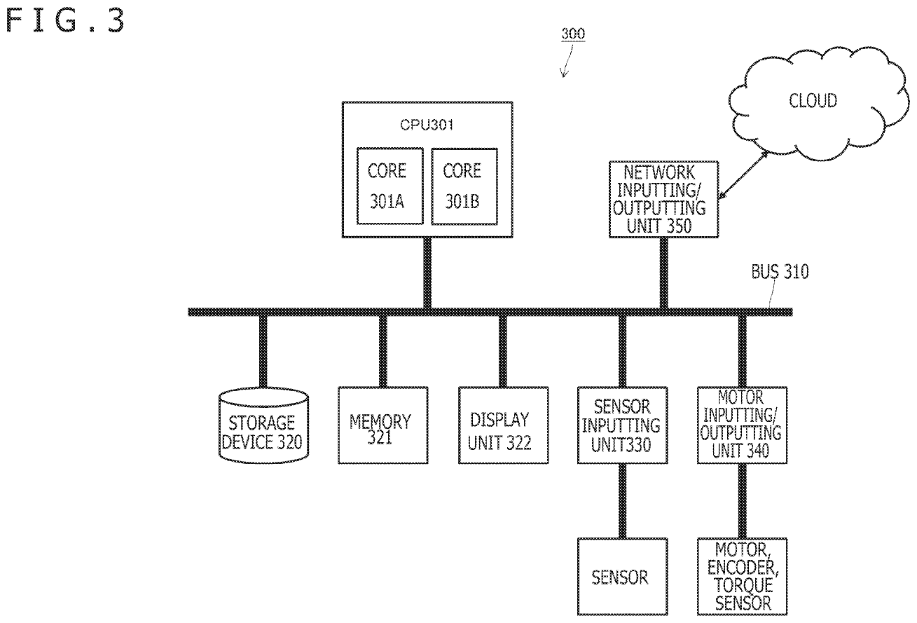

FIG. 3 depicts an example of a configuration of a control system 300 for the robot apparatus 100. Some or all of components of the control system 300 are built in the body unit 101. Alternatively, the control system 300 is an apparatus that is physically independent of the robot apparatus 100 and is connected by wireless or wired connection to the robot apparatus 100. For example, some or all of the components of the control system 300 may be installed on the cloud and mutually connected to the robot apparatus 100 via a network. Further, it is to be recognized that also a control system for the robot apparatus 200 is configured in a similar manner.

The control system 300 operates under the overall control of a CPU (Central Processing Unit) 301. In the example depicted, the CPU 301 has a multicore configuration including a processor core 301A and another processor core 301B. The CPU 301 is mutually connected to the components in the control system 300 through a bus 310.

A storage device 320 includes, for example, an external storage device of a large capacity such as a hard disk drive (HDD) or a solid-state drive (SSD) and stores files of programs to be executed by the CPU 301 and pieces of data that are used during execution of a program or are generated by execution of a program and so forth. The CPU 301 executes, for example, a device driver for driving the motors at the joint units of the robot apparatus 100, an image processing program for processing data imaged by the visual sensor 102, a path creation program for creating a path for the robot apparatus 100, and so forth.

A memory 321 includes a ROM (Read Only Memory) and a RAM (Random Access Memory). In the ROM, a startup program and basic inputting/outputting programs for the control system 300 are stored, for example. The RAM is used to load a program to be executed by the CPU 301 and temporarily store data to be used during execution of the program. For example, cost maps for individual gaits such as a leg gait and a wheel gait of the robot apparatus 100 created on a real time basis and the like are stored into the RAM.

A display unit 322 includes, for example, a liquid crystal display or an organic EL (Electro Luminescence) display. The display unit 322 displays data during execution of a program by the CPU 301 and a result of such execution. For example, a result of execution of the path creation program, a cost map for each gait of the robot apparatus 100, and so forth are displayed on the display unit 322.

A sensor inputting unit 330 performs signal processing for taking sensor signals from various sensors provided on the robot apparatus 100 such as the visual sensor 102 into the control system 300. A motor inputting/outputting unit 340 performs inputting and outputting processes of signals from and to the motors such as outputting of command signals to the motors at the joint units of the robot apparatus 100 and inputting of sensor signals of the encoders for detecting the position of the motors and torque sensors on the output power shaft side of the motors.

A network inputting/outputting unit 350 performs inputting and outputting processes between the control system 300 and the cloud. The network inputting/outputting unit 350 performs inputting and outputting processes for performing downloading of spot information on a path (Waypoints hereinafter described or the like) necessary for path creation for the robot apparatus 100 from the cloud, uploading of the created path information to the cloud, and so forth.

### C. Functional Configuration for Path Creation

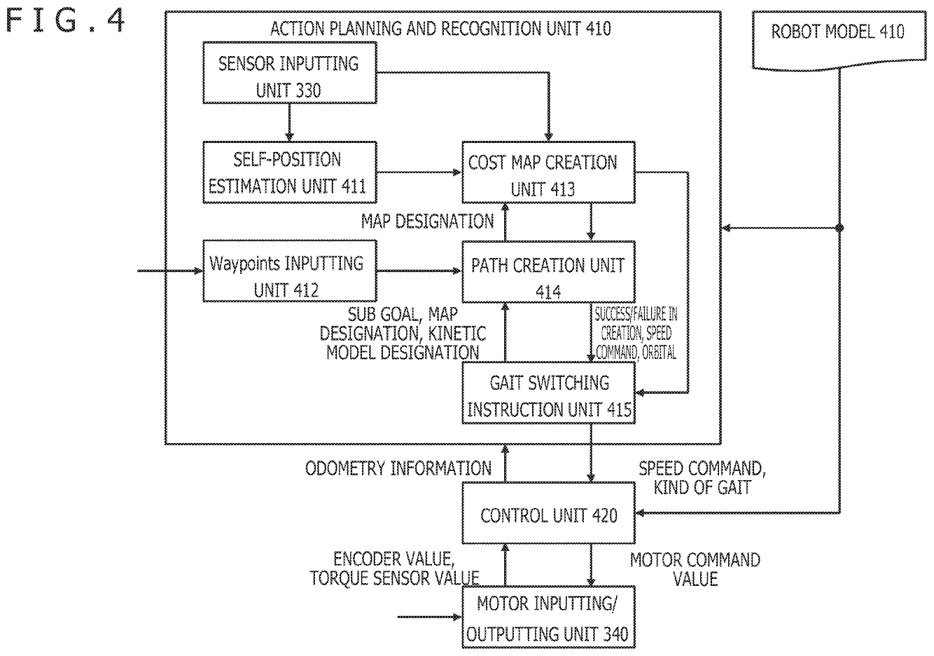

FIG. 4 schematically depicts an example of a functional configuration for performing path creation for the robot apparatus 100 in the control system 300. The functional blocks depicted are implemented by a combination of a software module that is executed by the CPU 301 and a hardware module of the robot apparatus 100 and the control system 300.

A robot model 400 includes basic information essentially required to use the target robot apparatus 100 (or the robot apparatus 200) such as information regarding a shape, a link length, a speed reduction ratio of a joint driving motor, a weight, and inertia. An action planning and recognition unit 410 and a control unit 420 take in the robot model 400. The action planning and recognition unit 410 and the control unit 420 include, for example, software modules to be executed by the CPU 301.

The path creation process for the robot apparatus 100 can be regarded as part of the action planning and recognition unit 410 that performs processing for recognizing an environment in reference to sensor information to create an action plan for the robot apparatus 100. The action planning and recognition unit 410 includes function modules for a self-position estimation unit 411, a Waypoints inputting unit 412, a cost map creation unit 413, a path creation unit 414 and a gait switching instruction unit 415 in order to perform the path creation process. The function modules 411 to 415 include, for example, software modules that are executed by the CPU 301.

The sensor inputting unit 330 receives sensor information of the visual sensor 102 (camera, TOF sensor, LiDAR, and so forth), IMU, and so forth and provides the sensor information to other modules.

The self-position estimation unit 411 performs estimation of the self-position of the robot apparatus 100 in reference to sensor information provided from the sensor inputting unit 330 and odometry information provided from the control unit 420. The self-position estimation unit 411 uses, for example, the SLAM (Simultaneous Localization and Mapping) algorithm.

The Waypoints inputting unit 412 receives, as input thereto, Waypoints outputted from a module that controls a global path plan outside or inside the control system 300 and provides the Waypoints to the modules in the action planning and recognition unit 410. The Waypoints is spot information on a path including a transit spot and a goal spot.

The cost map creation unit 413 creates a cost map representative of a travel cost for each of the gaits provided in the robot apparatus 100, in reference to sensor information provided from the sensor inputting unit 330 and the self-position of the robot apparatus 100 estimated by the self-position estimation unit 411. The cost map is a map that represents a travel cost required for the robot apparatus 100 to pass, for example, for each grid of a two-dimensional grid map. The size of the grid is, for example, approximately 5 cm×5 cm or 2.5 cm×2.5 cm. In the present embodiment, since the robot apparatus 100 allows selection between two kinds of gaits including the leg gait and the wheel gait, the cost map creation unit 413 creates two kinds of cost maps including a “leg cost map” for the leg gait and a “wheel cost map” for the wheel gait. Further, in a case where multiple kinds of gaits among which, although the same legs are used, the way of movement of the legs is different such as trot walking, crawl walking, and gallop walking are used, the cost map creation unit 413 creates a leg cost map for each of the kinds of gaits among which the walking method is different. Furthermore, also in a case where only trot walking is used, the speed of movement or the traversing performance differs depending upon the cycle in which the legs are moved. In this case, for each of the cycles in which the legs are moved, for example, a cost map for trot walking 1 Hz and a cost map for trot walking 2 Hz are created. Even where the land form or the obstacle is the same, the travel cost differs for each gait due to a difference in traversing performance for each gait or the like. Hence, an obstacle that is drawn on a wheel cost map for the wheels whose traversing performance is low may not be drawn (or is drawn but in a different manner) on a leg cost map for the legs whose traversing performance is high. It is to be noted that the cost map creation unit 413 updates the cost map for each gait, for example, in a period of several hundred milliseconds. Accordingly, on the cost maps for the individual gaits, information regarding not only static obstacles such as a land form, a stepped place, an object placed on the road surface, and so forth but also dynamic obstacles such as a person, an animal, a mobile body and so forth is drawn.

The path creation unit 414 gives to the cost map creation unit 413 an instruction regarding which cost map corresponding to the gait is required according to Waypoints provided from the Waypoints inputting unit 412 and then receives the cost map from the cost map creation unit 413. Then, the path creation unit 414 makes an attempt to create a path for which the applicable gait is used, according to the cost map, and outputs success/failure in creation indicative of whether or not a path is created successfully and, in a case where a path is created successfully, a speed command and an orbital for achieving the orbital to the gait switching instruction unit 415. The path creation unit 414 creates a path for the robot apparatus 100 by using, for example, a path creation algorithm that also allows obstacle avoidance such as Dynamic Window Approach (DWA).

The gait switching instruction unit 415 calculates, from a cost map for each gait acquired from the cost map creation unit 413, a gait switching point at which the robot apparatus 100 is to switch the gait on the path. Since the robot apparatus 100 includes the legs and the wheels as its moving means, the gaits are roughly divided into two including the leg gait and the wheel gait. Further, since the robot apparatus 100 includes four legs, the gaits in which the legs are used can be divided further into multiple kinds of gaits such as trot walking, crawl walking, gallop walking, and the like. Further, the gaits also include a periodical change of the gait, running, stealthy movement, and so forth. Since the gait switching instruction unit 415 searches for a gait switching point only on the path created by the path creation unit 414 as hereinafter described, calculation resources can be reduced. Further, the gait switching instruction unit 415 gives to the control unit 420 an instruction regarding switching of the kind of the gait of the robot apparatus 100 and a speed command.

The control unit 420 gives to the motor inputting/outputting unit 340 an instruction regarding a command value for each joint driving motor of the robot apparatus 100 for performing a designated gait, according to a command from the gait switching instruction unit 415. Further, the control unit 420 outputs odometry information to the action planning and recognition unit 410 in reference to detection information of an encoder (rotation angle of the output power shaft of the motor) fed back from the motor inputting/outputting unit 340.

The motor inputting/outputting unit 340 performs inputting and outputting processes of signals to and from the motors such as outputting of a command signal to the motor at each joint unit of the robot apparatus 100, inputting of sensor signals of the encoder for detecting the position of each motor and the torque sensor on the output power shaft side of each motor, and so forth. Further, the motor inputting/outputting unit 340 feeds back the detection signals of the encoders and the torque sensors to the control unit 420.

### D. Path Creation Procedure

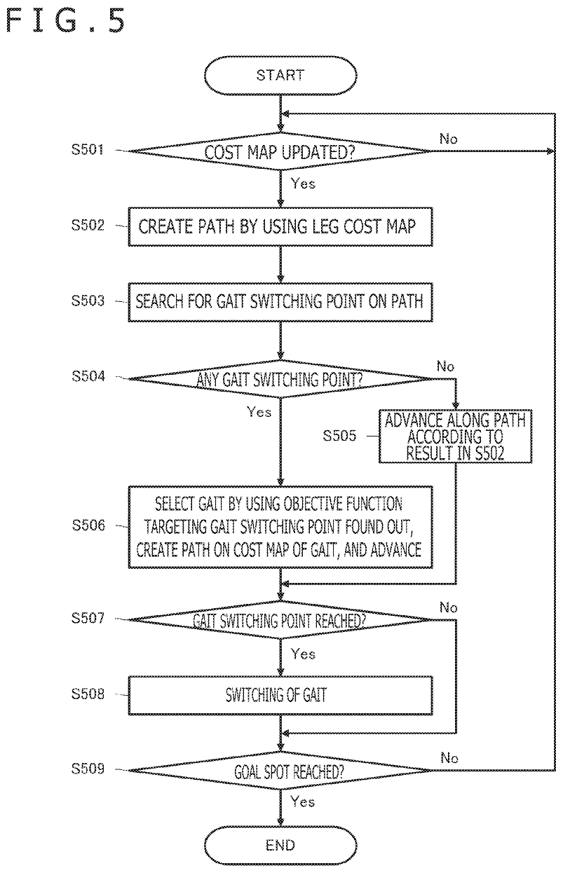

FIG. 5 depicts, in the form of a flow chart, a processing procedure for performing path creation for the robot apparatus 100 with use of the functional configuration depicted in FIG. 4. In the following description, in order to simplify the description, it is assumed that the robot apparatus 100 allows selection between the two kinds of gaits including the leg gait and the wheel gait and that the leg gait is a gait which is “high in traversing performance, but low in speed” while the wheel gait is a gait which is “high in speed, but low in traversing performance.” Further, it is assumed that the cost map creation unit 413 creates a leg cost map and a wheel cost map as cost maps for the individual gaits.

If none of the cost maps is updated by the cost map creation unit 413, nothing is done (No in step S501). If a cost map is updated by the cost map creation unit 413 (Yes in step S501), then the path creation unit 414 creates a path on a cost map for a gait which is high in traversing performance (in the present embodiment, on the leg cost map) (step S502). As a result, the shortest route in the tolerant or stable gait is obtained.

Then, the gait switching instruction unit 415 makes an attempt to calculate a gait switching point at which the robot apparatus 100 is to switch the gait on the path from the cost map for each gait acquired from the cost map creation unit 413 (step S503). In particular, the gait switching instruction unit 415 makes a search as to whether there is a gait switching point on the path created in step S502 toward an advancing direction from the self-position of the robot apparatus 100. The gait switching instruction unit 415 can calculate the difference between the leg cost map and the wheel cost map and find out a point at which the difference and the path cross with each other as a gait switching point. According to the present disclosure, since search for a gait switching point is performed only on the path, calculation resources can be reduced. For example, in a case where there is an obstacle and the movement cost with which the robot apparatus 100 traverses the obstacle differs for each gait such as the leg gait or the wheel gait, the difference between the cost maps for each gait is great.

In a case where there is no gait switching point on the path (No in step S504), the robot apparatus 100 advances along the path as created in step S502 (step S505). The gait switching instruction unit 415 gives to the control unit 420 an instruction regarding switching of the kind of the gait for the robot apparatus 100 and a speed command. Then, the control unit 420 gives, according to the command from the gait switching instruction unit 415, to the motor inputting/outputting unit 340 an instruction regarding a command value for each joint driving motor of the robot apparatus 100 for performing the designated gait.

On the other hand, in a case where there is a gait switching point on the path (Yes in step S504), the gait switching instruction 415 uses an objective function (time, energy, distance) to select a gait targeting the gait switching point found out in step S503, and the path creation unit 414 creates a path on the map of the selected gait. Then, the robot apparatus 100 advances toward the gait switching point according to the selected gait and the path created on the cost map of the gait (step S506). The reason why path creation is performed once again in step S506 is that it is necessary to take the dynamics of the selected gait into consideration. It is to be noted that, on the cost map of each gait, not only static obstacles but also dynamic obstacles are drawn (as described hereinabove), and a point at which the robot apparatus 100 is to cross with a dynamic obstacle present on the path is sometimes found out as a gait switching point.

Thereafter, it is checked whether the robot apparatus 100 has reached the gait switching point (step S507). For this check, the self-position of the robot apparatus 100 estimated by the self-position estimation unit 411 is used.

In a case where the robot apparatus 100 has reached the gait switching point (Yes in step S507), the gait switching instruction unit 415 gives to the control unit 420 an instruction regarding switching of the gait, and the robot apparatus 100 switches the gait (step S508). On the other hand, in a case where the robot apparatus 100 has not yet reached the gait switching point (No in step S507), the robot apparatus 100 skips the switching of the gait (step S508).

Then, until the robot apparatus 100 reaches a goal spot inputted to the Waypoints inputting unit 412 (No in step S509), the processing returns to step S501, and the robot apparatus 100 repetitively executes the processes described above.

Since the robot apparatus 100 has such a functional configuration as depicted in FIG. 4 and advances while determining the shortest path with a gait that is high in traversing performance, extracting a gait switching point (sub goal), and selecting a necessary gait with use of an objective function, by performing path creation in accordance with the processing procedure depicted in FIG. 5, less waste is expected. Accordingly, path creation for the robot apparatus 100 can be performed on a real time basis. As a result, path creation including switching of a gait with less calculation resources and a dynamic obstacle being taken into consideration is facilitated.

### E. Specific Example of Path Creation

Next, specific examples in which path creation for the robot apparatus 100 is performed with use of the functional configuration depicted in FIG. 4 are described.

Also in this paragraph, it is assumed for simplification of the description that the robot apparatus 100 allows selection between two kinds of gaits including the leg gait and the wheel gait and the leg gait is a gait which is “high in traversing performance, but low in speed” and the wheel gait is a gait which is “high in speed, but low in traversing performance.”

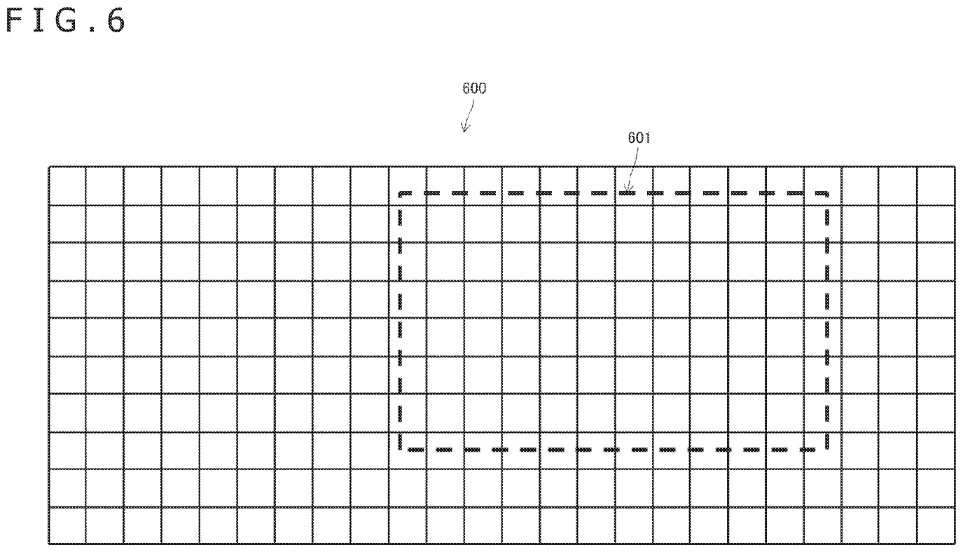

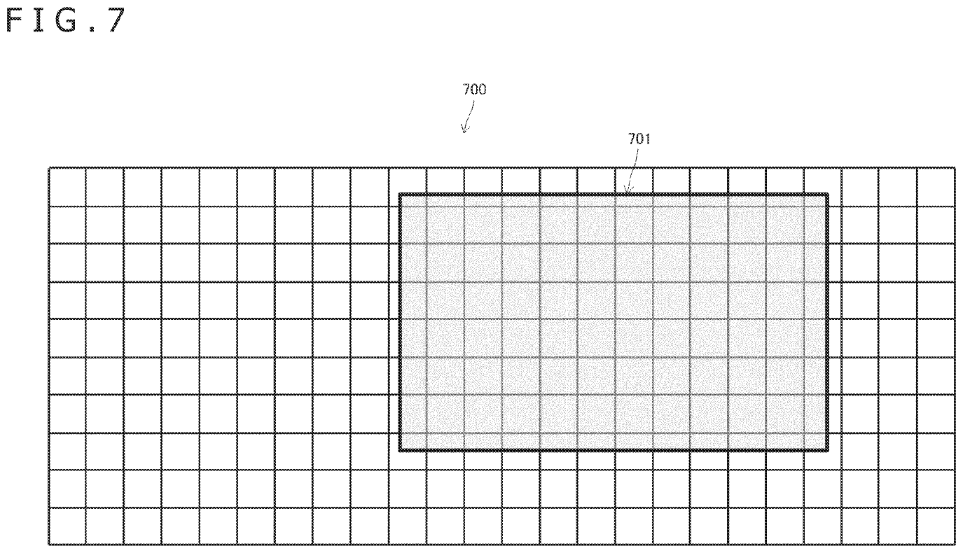

Further, in the description given hereinbelow, a leg cost map 600 depicted in FIG. 6 and a wheel cost map 700 depicted in FIG. 7 are assumed. The leg cost map 600 and the wheel cost map 700 are maps that represent a travel cost required for passage of the robot apparatus 100 for each of grids of a two-dimensional grid map. FIGS. 6 and 7 depict cost maps of the same place and include stepped places 601 and 701, respectively. The leg gait (walking) is a gait that is high in traversing performance, and the cost is substantially fixed also at the stepped place 601. On the other hand, the wheel gait is a gait that is low in traversing performance, so that the wheels cannot ride over the stepped place 701, resulting in a significantly increased travel cost in the region in the stepped place 701. In the wheel cost map depicted in FIG. 7, the inside of the stepped place 701 that is high in travel cost is represented by gray. It is to be noted that, although the following description is made regarding a static obstacle such as the stepped place 601 or 701 for simplified explanation, the cost map creation unit 413 can update the cost map for each gait, for example, for every several hundred milliseconds and can also draw a dynamic obstacle on the cost map for each gait.

### E-1. Specific Example 1

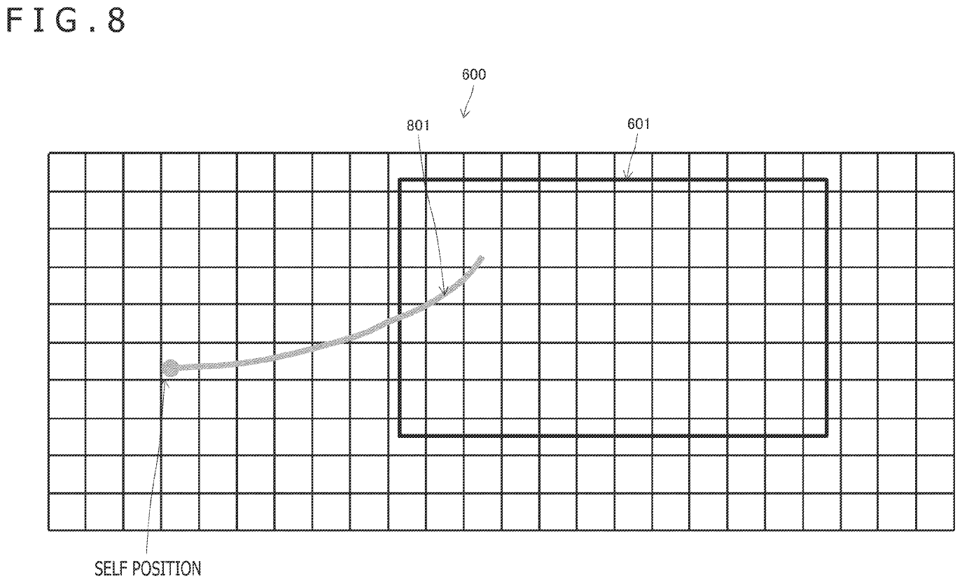

FIG. 8 depicts a path 801 from the self-position of the robot apparatus 100 created on the leg cost map 600 for high traversing performance in step S502 in the flow chart depicted in FIG. 5.

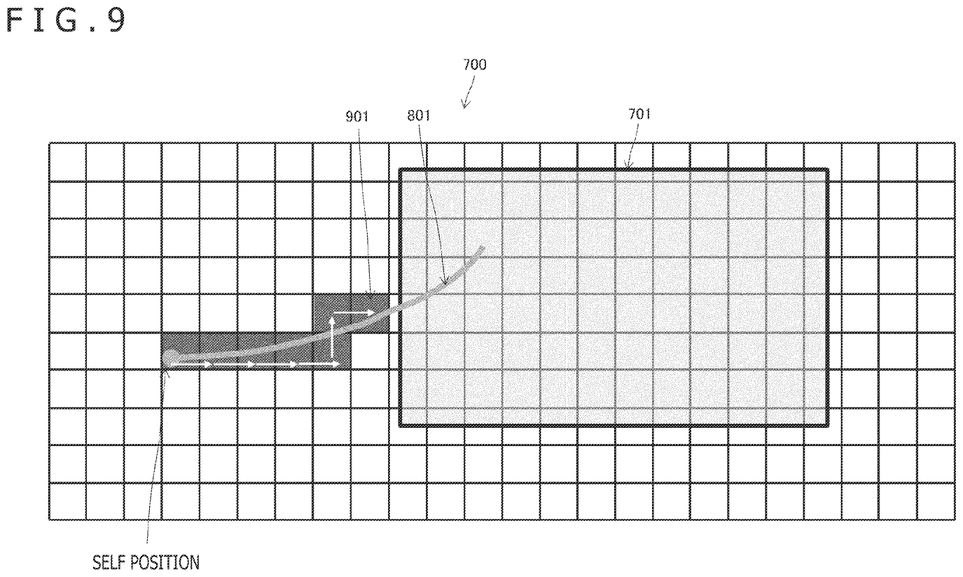

FIG. 9 depicts a specific example of a search process for a gait switching point on a path, which is executed in step S503 in the flow chart depicted in FIG. 5. The robot apparatus 100 moves on the path 801 with the wheels by using the wheel cost map 700. In FIG. 9, grids on which the robot apparatus 100 moves with the wheels along the path 801 are represented in dark gray. A grid 901 immediately prior to the stepped place 701 at which the travel cost increases on the path 801 becomes a gait switching point. The gait switching instruction unit 415 can calculate the difference between the leg cost map and the wheel cost map and find out a point at which the difference and the path cross with each other, as the gait switching point.

### E-2. Specific Example 2

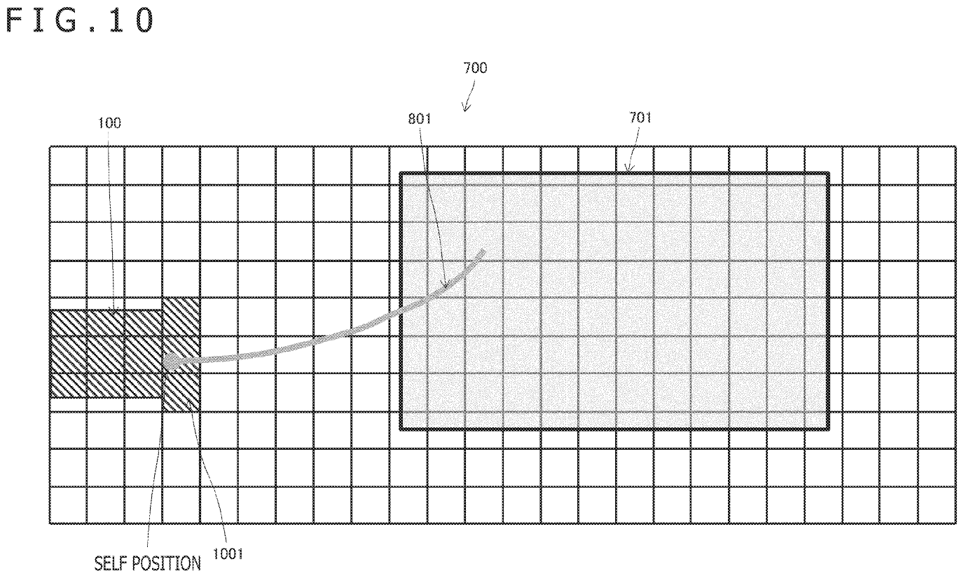

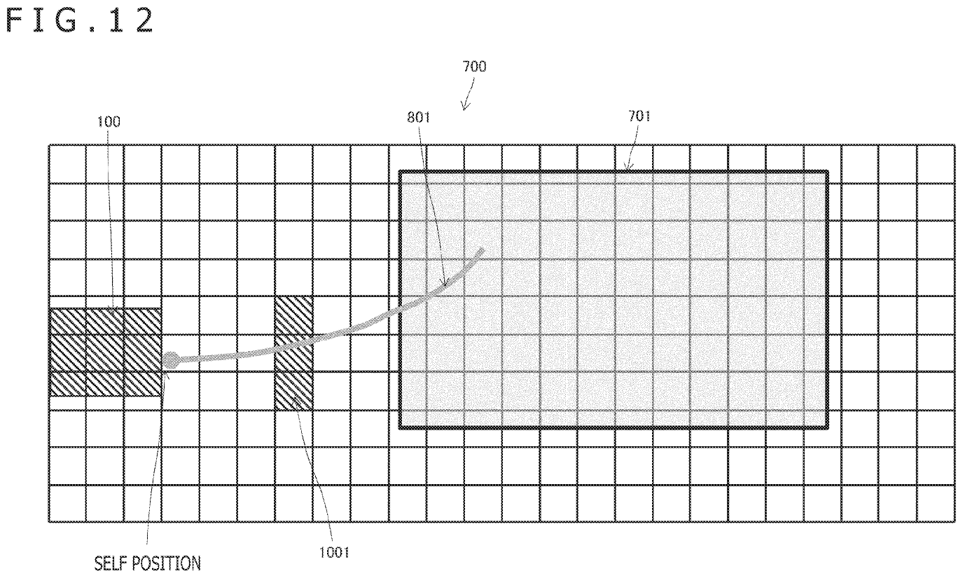

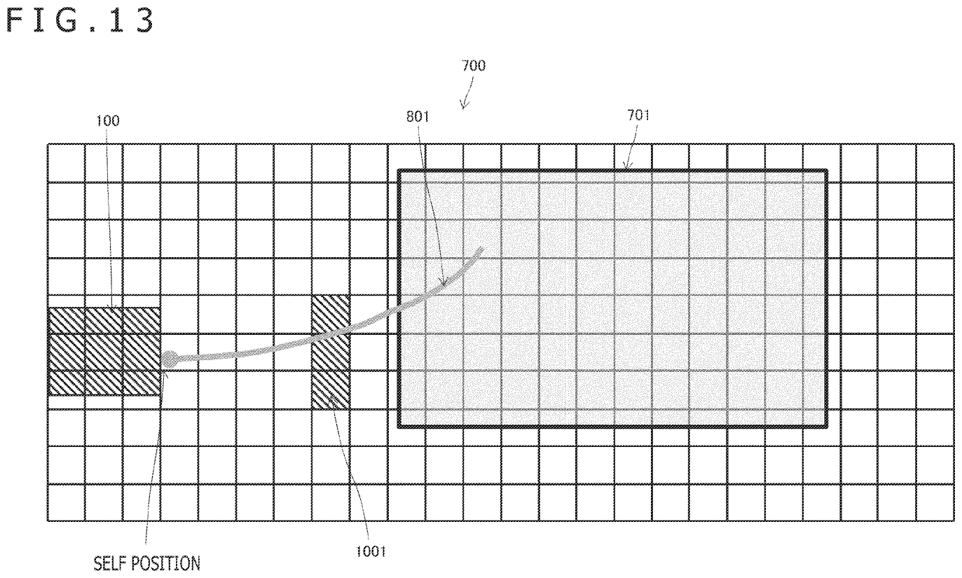

In the example of search for a gait switching point depicted in FIGS. 8 and 9, the robot apparatus 100 is treated as a point on the cost map, and the size and the shape of the robot apparatus 100 are not taken into consideration. In contrast, FIGS. 10 to 14 depict an example in which a gait switching point is searched for taking the size of the robot apparatus 100 into consideration. It is to be noted that, since the description is given with gait switching being limited to one switching the wheel gait to the leg gait with reference to FIGS. 10 to 14, it is sufficient if only the width among physical properties of the robot apparatus 100 is taken into consideration, and therefore, the robot apparatus 100 is treated as a block of a width of 3 grids.

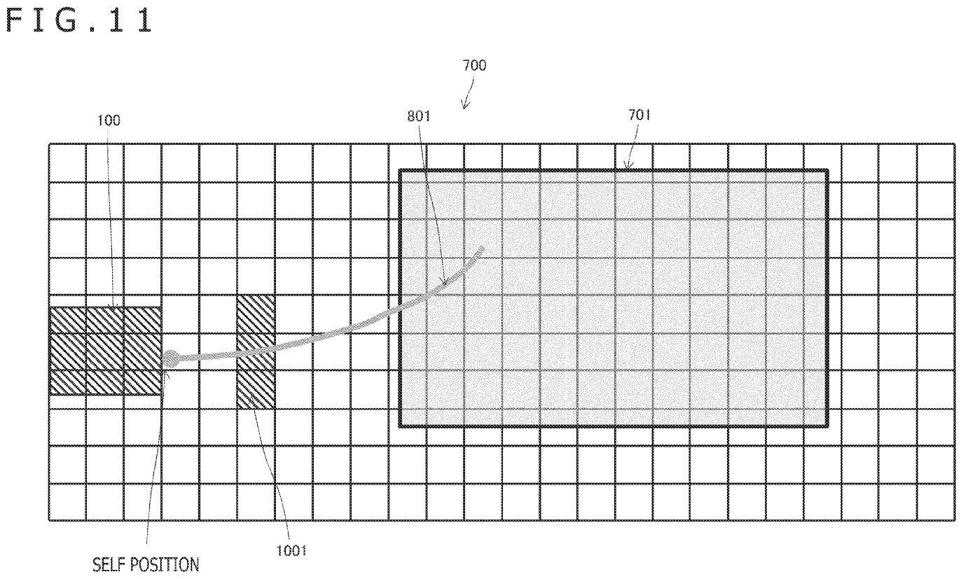

The robot apparatus 100 has a width of 3 grids on the cost map. As such, a block 1001 having a width of 3 grids is placed at the self-position of the robot apparatus 100 as depicted in FIG. 10. Then, as illustrated in FIGS. 11 to 14, the block 1001 is moved one by one grid toward a goal spot along the path 801 created on the leg cost map 700. It is assumed that the robot apparatus 100 moves by using the wheels.

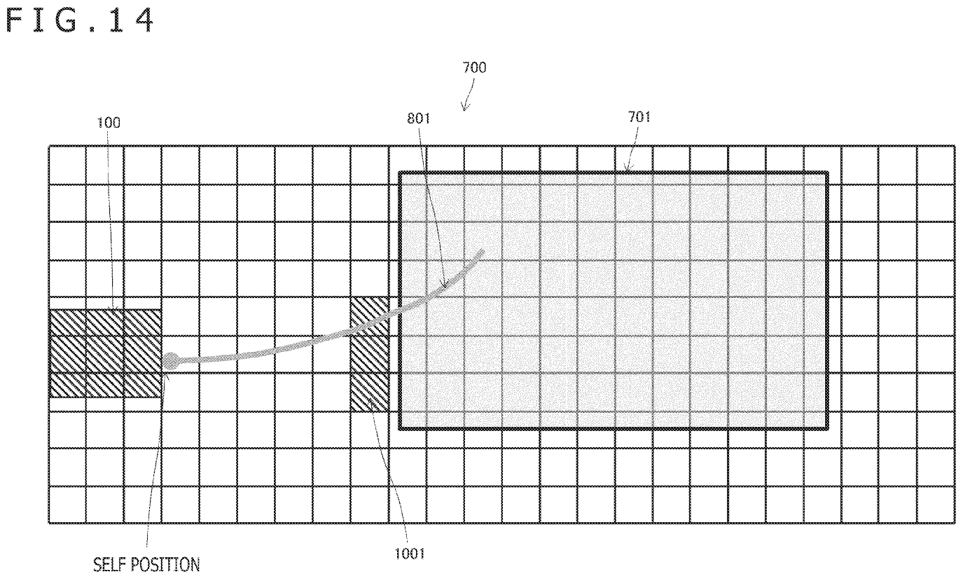

Then, as depicted in FIG. 14, a position of the block 1001 immediately prior to reaching the stepped place 701 at which the travel cost increases becomes a gait switching point (or a gait switching position) for switching from the wheel gait to the leg gait that is high in traversing performance. Taking the physical property of the robot apparatus 100 into consideration, gait switching can be carried out in a safe manner irrespective of the shape of the robot apparatus 100.

### E-3. Specific Example 3

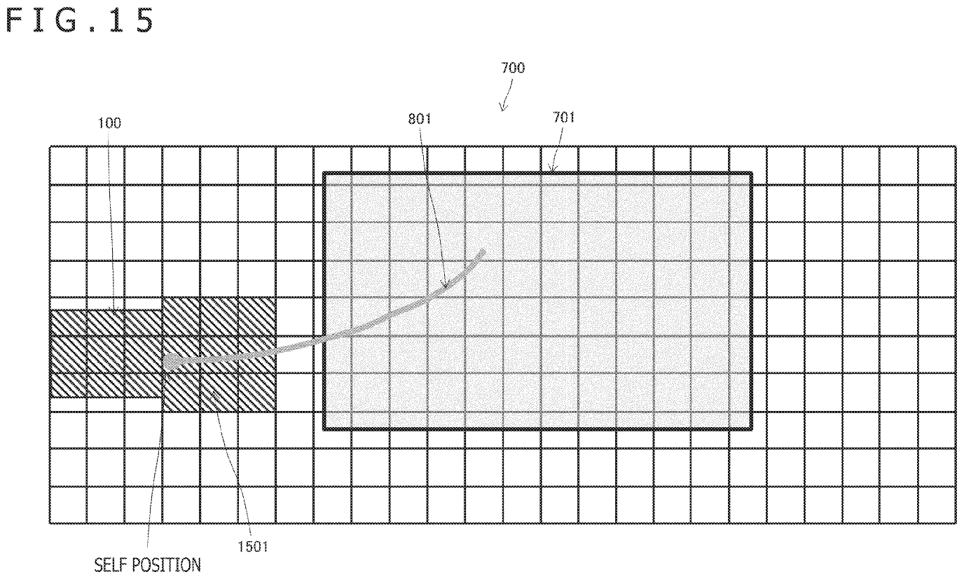

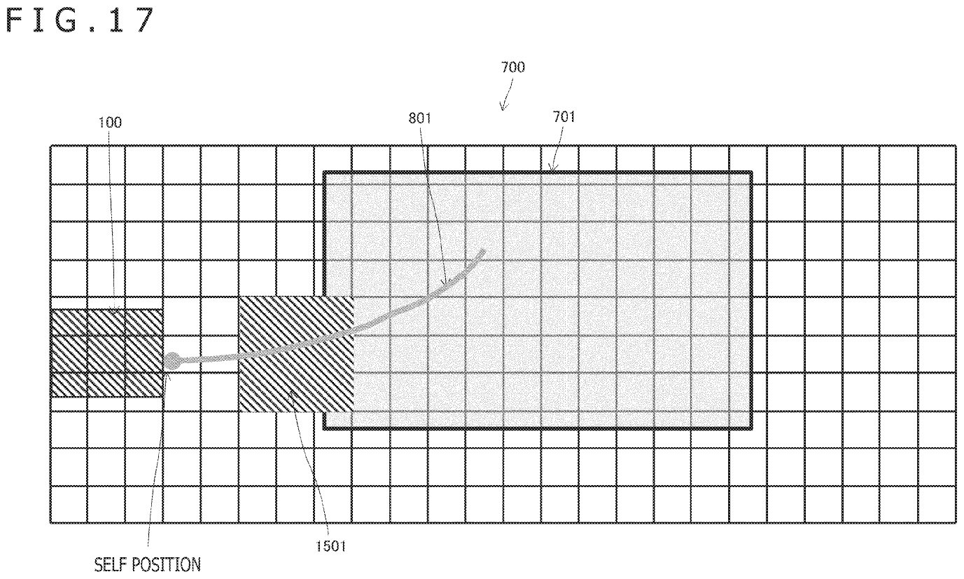

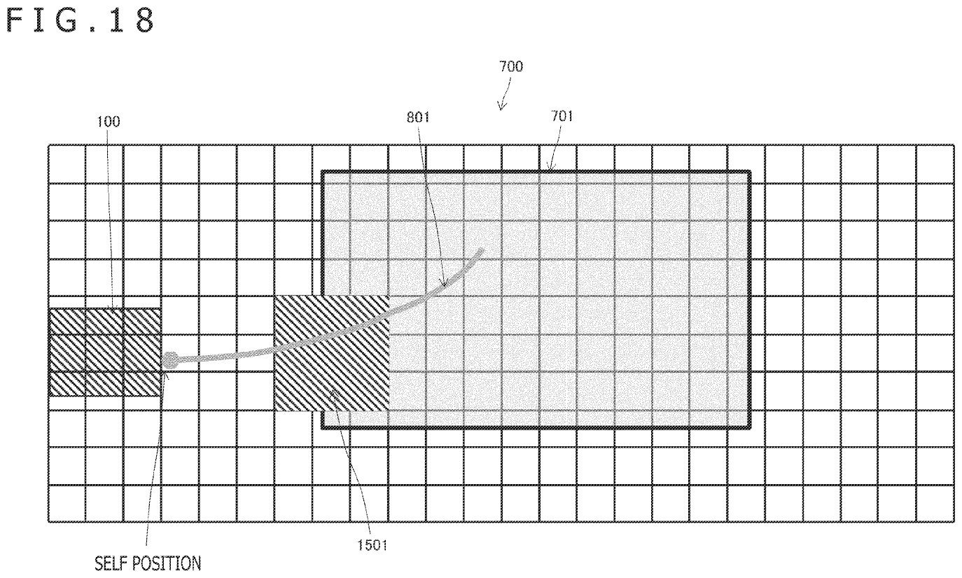

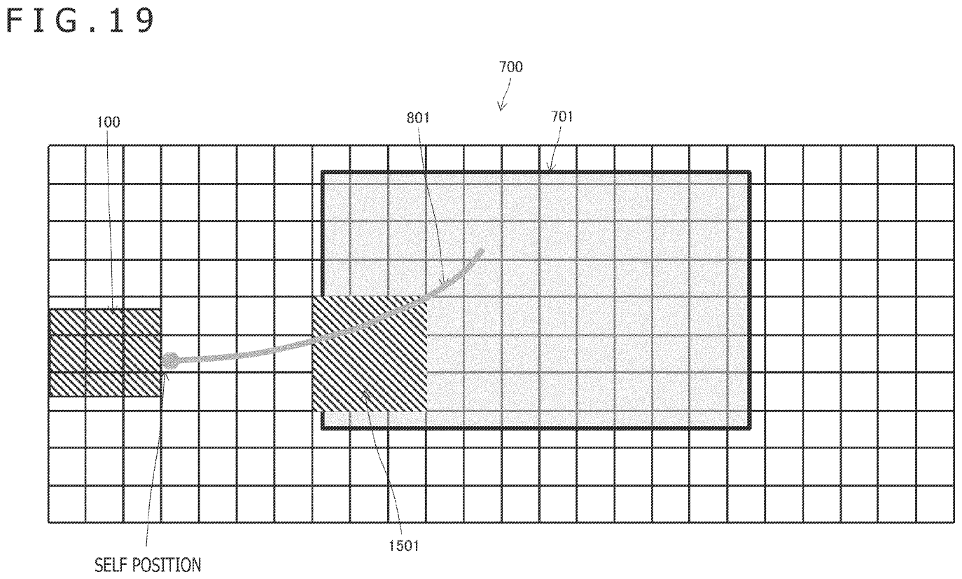

FIGS. 15 to 20 depict another example in which gait switching is performed when the robot apparatus 100 passes a gait switching point, taking the shape and the size of the robot apparatus 100 into consideration. In FIGS. 15 to 20, the robot apparatus 100 has a size of 3×3 grids on the cost map. It is to be noted that, in order to also describe gait switching after the entire robot apparatus 100 has passed a gait switching point, it is necessary to take the width and the thickness among the physical properties of the robot apparatus 100 into consideration, and hence, in FIGS. 15 to 20, the robot apparatus 100 is treated as a block having an area of 3×3 grids.

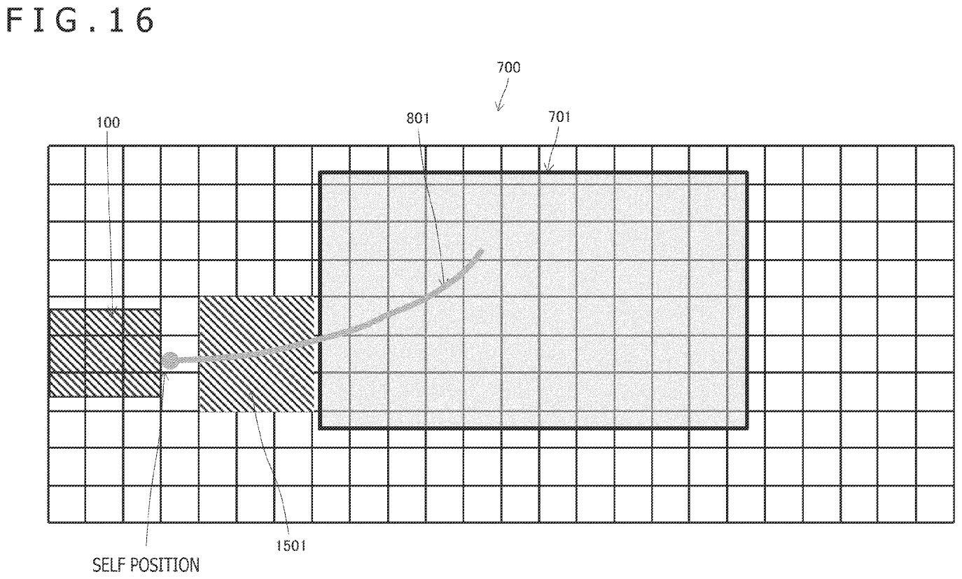

A block 1501 of 3×3 grids is placed at the self-position of the robot apparatus 100 as depicted in FIG. 15. At this point of time, the block 1501 is being moved in the gait by the wheels that is high in travel speed. Then, when the leading end of the block 1501 comes to a point immediately prior to the stepped place 701 as depicted in FIG. 16, the point becomes a gait switching point for switching from the wheel gait to the leg gait that is high in traversing performance. The block 1501 is moved one by one grid toward a goal spot along the path 801 created on the leg cost map 700 as depicted in FIGS. 16 to 20. It is assumed that the robot apparatus 100 moves by using the leg gait that is high in traversing performance.

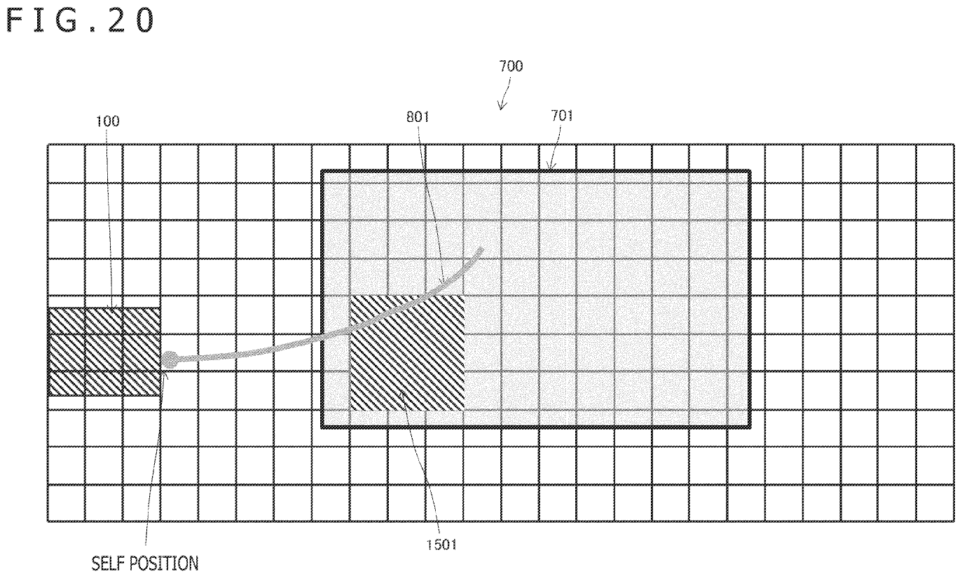

Then, when the trailing end of the block 1501 passes the stepped place 701 as depicted in FIG. 20, the entire robot apparatus 100 has ridden up to the stepped place 701. Although, in order to traverse the stepped place 701, the robot apparatus 100 has to switch the gait from the wheel gait to the leg gait, after the robot apparatus 100 has traversed the stepped place 701, the robot apparatus 100 returns to the state of using the gait by the wheels that is high in travel speed and can thereafter move on the stepped place 701.

By treating the robot apparatus 100 as the block 1501 of 3×3 grids on the cost map in such a manner, a safe place where the robot apparatus 100 has fully climbed the stepped place 701 can be made a gait switching point for switching from the leg gait to the wheel gait. Gait switching can be carried out in a safe manner by taking the physical property of the robot apparatus 100 into consideration, irrespective of the shape of the robot apparatus 100.

### E-4. Specific Example 4

Also in specific example 4, in order to also describe gait switching after the entire robot apparatus 100 has passed a gait switching point, it is necessary to take the width and the thickness from among the physical properties of the robot apparatus 100 into consideration, and hence, the robot apparatus 100 is treated as a block having an area of 3×3 grids as in specific example 3 described above.

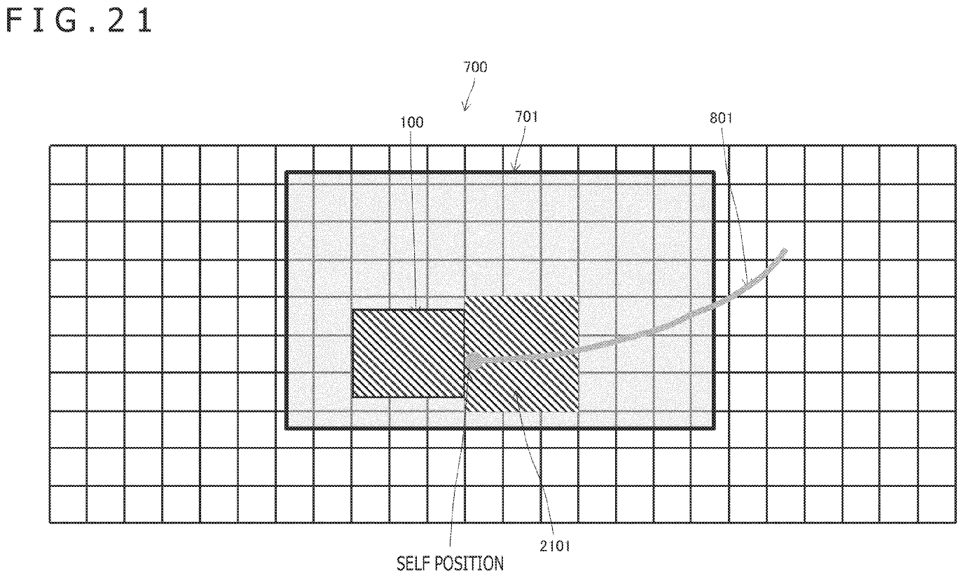

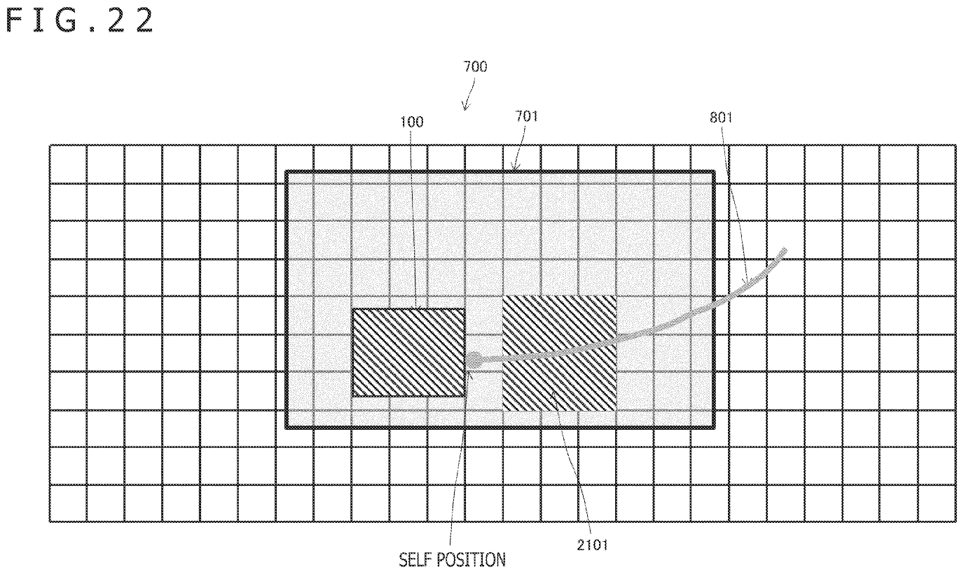

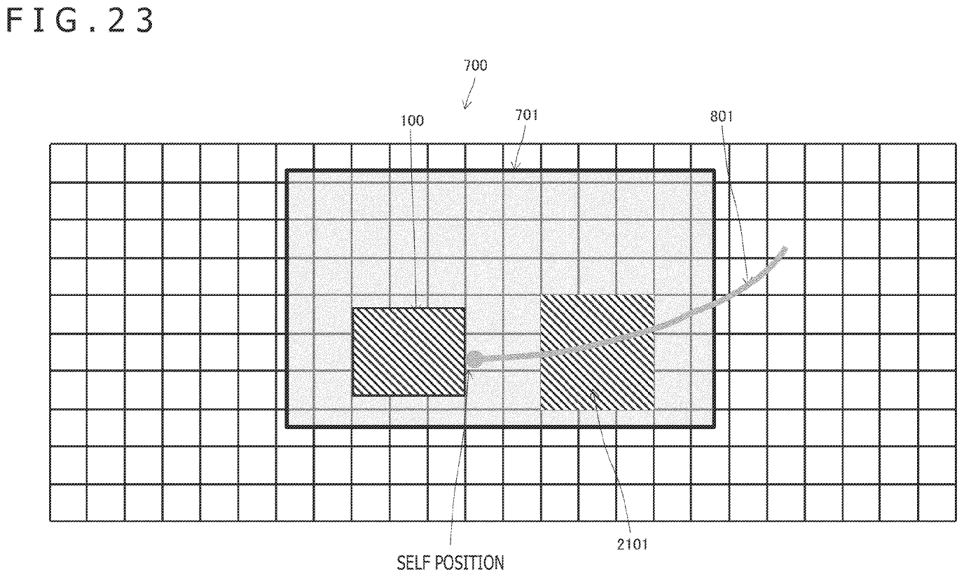

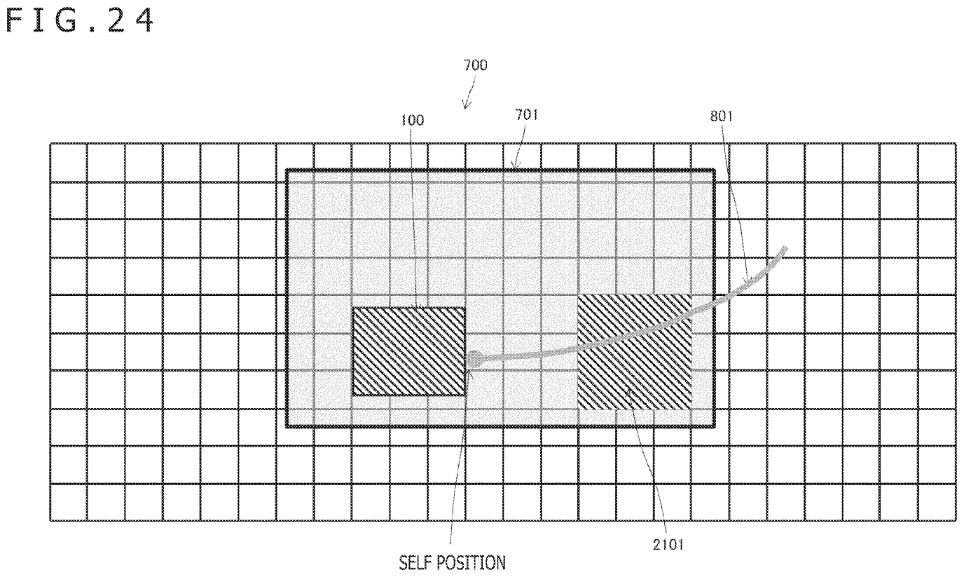

A block 2101 of 3×3 grids is placed at the self-position of the robot apparatus 100 present on the stepped place 701 as depicted in FIG. 21. Then, the block 2101 is moved one by one grid toward a goal spot along the path 801 created on the leg cost map 700, as illustrated in FIGS. 22 to 24. It is assumed that the robot apparatus 100 moves with use of the wheels. Then, as depicted in FIG. 24, a position of the block 2101 immediately prior to reaching the stepped place 701 at which the travel cost increases becomes a gait switching point (or a gait switching position) for switching from the wheel gait to the leg gait which is high in traversing performance.

By treating the robot apparatus 100 as the block 2101 of 3×3 grids on the cost map in such a manner, a position immediately prior to the stepped place 701 can be made a gait switching point for switching from the wheel gait to the leg gait which is high in traversing performance. Gait switching can be carried out in a safe manner by taking the physical property of the robot apparatus 100 into consideration, irrespective of the shape of the robot apparatus 100.

### E-5. Specific Example 5

Also in specific example 5, in order to also describe gait switching after the entire robot apparatus 100 has passed a gait switching point, it is necessary to take the width and the thickness among the physical properties of the robot apparatus 100 into consideration, and hence, the robot apparatus 100 is treated as a block having an area of 3×3 grids as in specific example 3 described above.

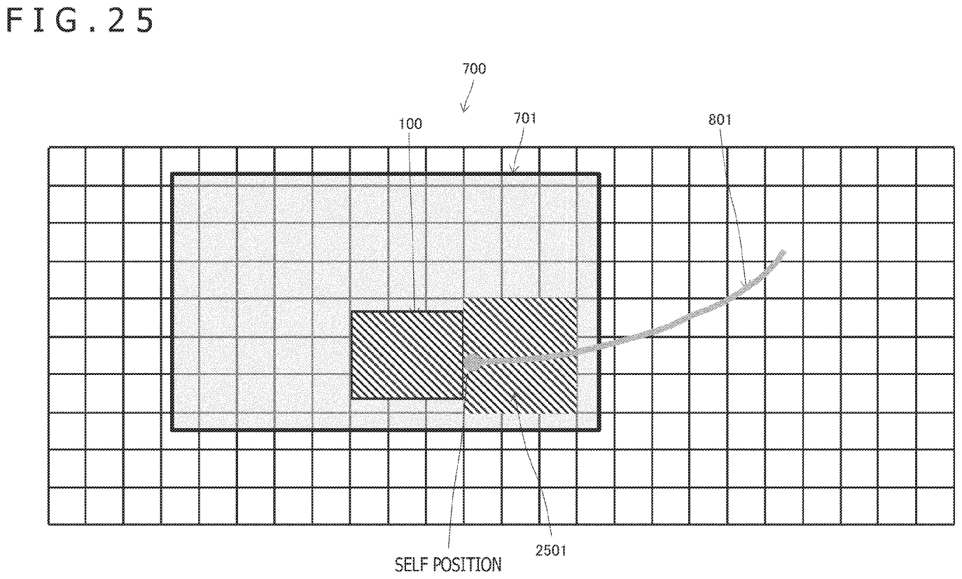

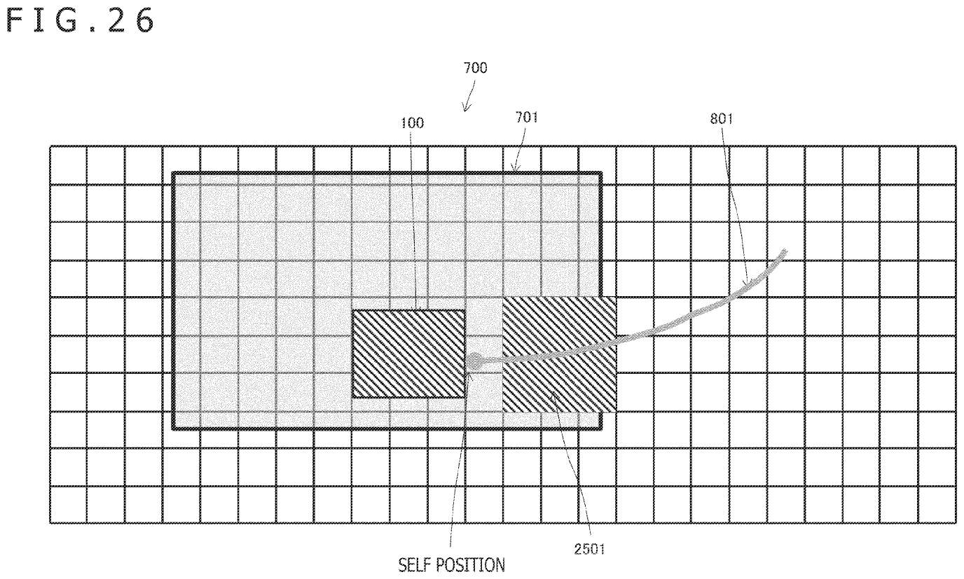

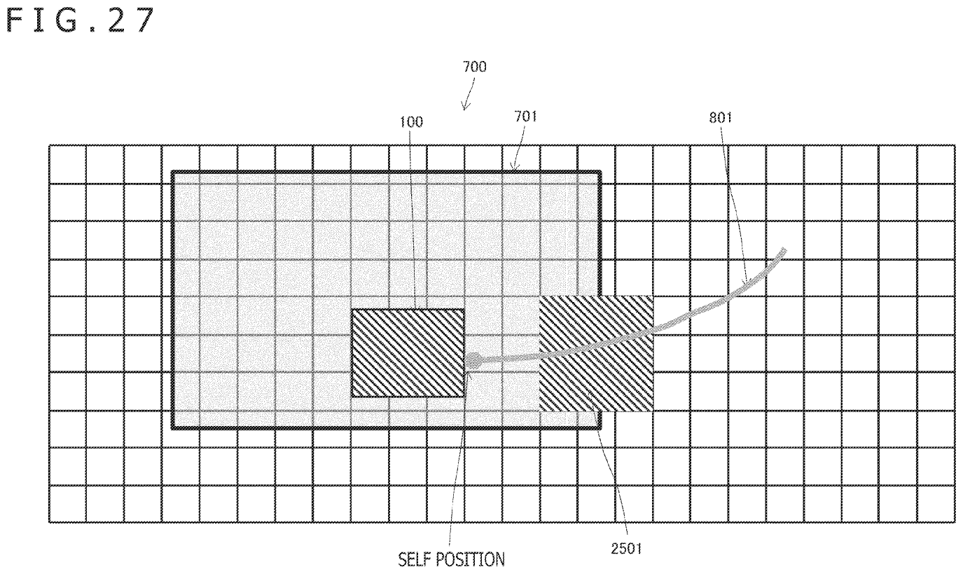

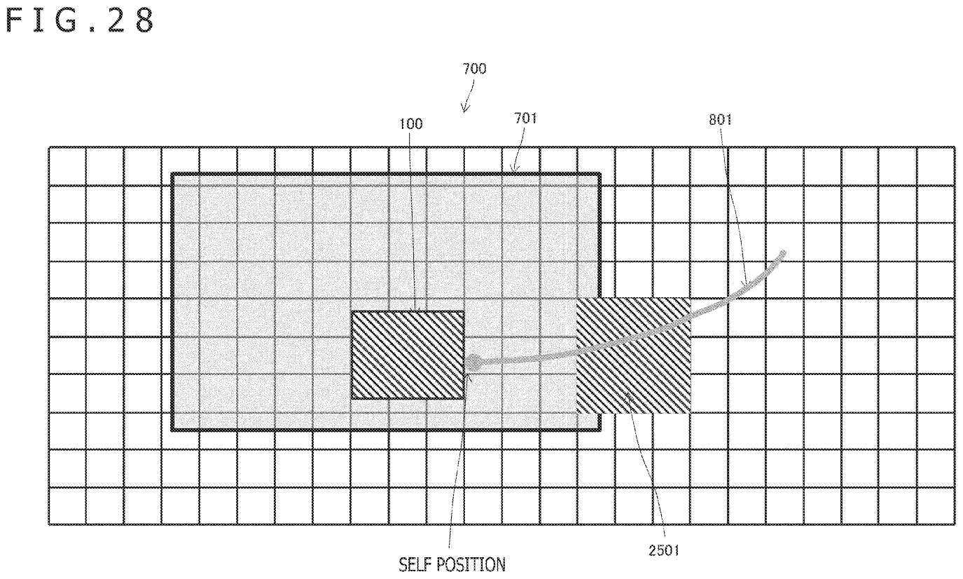

A block 2501 of 3×3 grids is placed at the self-position of the robot apparatus 100 present at a position immediately prior to the terminal end of the stepped place 701 as depicted in FIG. 25. Then, the block 2501 is moved one by one grid toward a goal spot along the path 801 created on the leg cost map 700 as depicted in FIGS. 26 to 29. It is assumed that the robot apparatus 100 moves with use of the leg gait which is high in traversing performance.

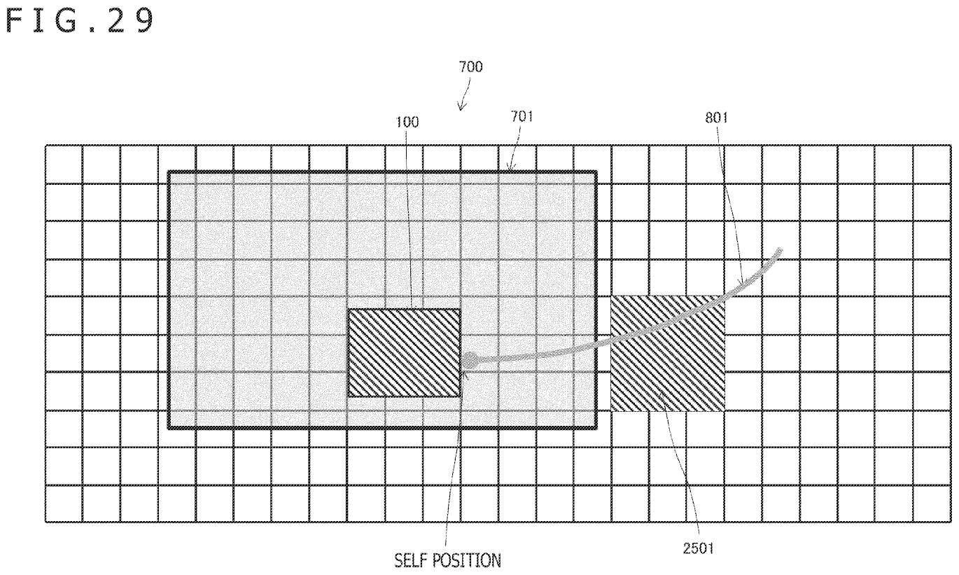

Then, when the terminal end of the block 2501 passes the stepped place 701, the entire robot apparatus 100 has fully stepped down on a flat face below the stepped place 701 as depicted in FIG. 29. Although, in order to traverse the stepped place 701, it has been necessary for the robot apparatus 100 to switch its gait from the wheel gait to the leg gait, after the robot apparatus 100 has traversed the stepped place 701, the robot apparatus 100 returns to the state of using the gait by the wheels which is high in travel speed is high and can thereafter move on the stepped place 701.

By treating the robot apparatus 100 as the block 2501 of 3×3 grids on the cost map in such a manner, a safe place where the robot apparatus 100 has stepped down from the stepped place 701 can be made a gait switching point for switching from the leg gait to the wheel gait. Gait switching can be carried out in a safe manner by taking the physical property of the robot apparatus 100 into consideration, irrespective of the shape of the robot apparatus 100.

### F. Modification of Path Creation Procedure

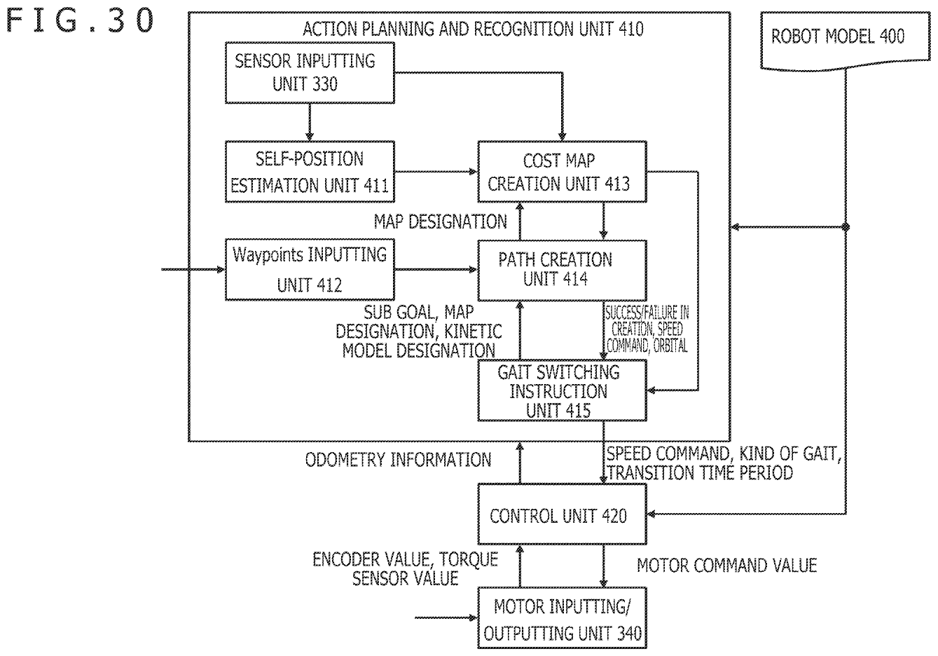

In FIG. 5, a flow chart of the processing procedure for performing path creation for the robot apparatus 100 with use of the functional configuration is depicted. In step S508 of this flow chart, the gait switching instruction unit 415 instructs the control unit 420 to switch the gait, and the robot apparatus 100 switches the gait. The gait switching instruction unit 415 may otherwise give to the control unit 420 an instruction regarding transition time period of gait switching in addition to the type of the gait or the speed command. FIG. 30 depicts an example of a functional configuration for performing path creation for the robot apparatus 100 in this case. In this example of the configuration, the gait switching instruction unit 415 instructs the control unit 420 to perform switching of the gait.

The control unit 420 performs control such that the gait is switched smoothly within a transition time period designated by the gait switching instruction unit 415. For example, if the gait switching is performed at a cycle of a gait, then the control unit 420 performs such a countermeasure as to connect gaits before and after gait switching to each other within the transition time period by spline interpolation.

When the gait switching instruction unit 415 gives to the control unit 420 an instruction regarding a transition time period for gait switching, the robot apparatus 100 can carry out gait switching without temporarily stopping. Since the robot apparatus 100 need not stop every time the gait is to be switched, it is possible for the robot apparatus 100 to reach a destination in a shorter period of time.

### G. Characteristics and Advantageous Effects of Present Disclosure

Characteristics and advantageous effects of the present disclosure are summarized.

(1) According to the present disclosure, path creation including switching of the gait can be performed using two or more kinetic models of the robot apparatus 100 and two or more cost maps (or cost maps for individual kinetic models). According to the present disclosure, after the shortest path to a destination is searched out on the cost map of the gait which is high in traversing performance, search for a gait switching point on the path is performed. Then, in a case where there is a gait switching point, a path is re-searched for on the cost map of the gait selected by an objective function with the gait switching point set as a sub goal. Accordingly, according to the present disclosure, since a gait switching point that becomes a sub goal is extracted after the shortest path is determined with the gait high in traversing performance and then a necessary gait is selected using an objective function to perform movement, real time path creation can be performed with less waste. As a result, path creation including gait switching with a dynamic obstacle taken into consideration can be implemented with less calculation resources.

(2) According to the present disclosure, search for a gait switching point can be performed by taking a physical property of the robot apparatus 100 into consideration. Accordingly, gait switching can be carried out in a safe manner irrespective of the shape and the size of the robot apparatus 100.

(3) According to the present disclosure, when the robot apparatus 100 moves on a path while performing gait switching, a transition time period for gait switching can be provided. Accordingly, the robot apparatus 100 can implement gait switching without stopping and can reach a destination in a shorter period of time.

### INDUSTRIAL APPLICABILITY

The present disclosure has been described in detail above with reference to the specific embodiment. However, it is obvious that those skilled in the art can perform modification or substitution of the embodiment without departing from the spirit and scope of the present disclosure.

Although, in the present specification, description has been given principally of the embodiment in which the present disclosure is applied to a four-legged robot and a two-legged robot that allow selection between two kinds of gaits including the leg gait and the wheel gait, the subject matter of the present disclosure is not limited to this. Further, although, in the present specification, description has been given principally of the embodiment that uses cost maps that include only a static obstacle, for the convenience of description, it is also possible to draw a dynamic obstacle on the cost maps of the individual gaits, and the present disclosure can perform path creation including gait switching for a robot individually corresponding to a sexual obstacle and a dynamic obstacle.

The present disclosure can be applied similarly to various types of mobile robot apparatuses that allow selection from among multiple gaits that are different in traversing performance and travel speed from each other such as, for example, a mobile robot apparatus in which three or more kinds of gaits including a leg gait and a wheel gait can be selected, a mobile robot apparatus in which multiple gaits including three legs or five or more legs can be selected, and a mobile robot apparatus in which multiple gaits that do not include at least one of a leg gait and a wheel gait can be selected.

Further, the present disclosure can also be applied similarly to a legged robot in which, although being equipped only with a single kind of leg as the movement mechanism, multiple gaits that are different in traversing performance and travel speed depending upon the difference in cycle in which the legs are moved or in kinetic model such as trot walking, crawl walking, and gallop walking can be selected.

Further, the present disclosure can also be applied similarly to an unmanned aircraft that has multiple flight modes that are different in stability and travel speed of the machine body upon flight, by using three-dimensional cost maps.

In short, the present disclosure has been described in the form of exemplification, and the contents of the description of the present specification shall not be interpreted in a limited manner. In order to determine the subject matter of the present disclosure, the claim should be taken into consideration.

It is to be noted that the present disclosure can assume also such configurations as described below.

(1) A control apparatus for a robot, including:

a cost map creation unit that creates a cost map for each of gaits of the robot that allows selection from among multiple gaits; and

a path creation unit that creates a path including gait switching for the robot by using the cost maps created by the cost map creation unit.

(2) The control apparatus according to (1) above, in which

the path creation unit searches for the shortest path by using the cost map of the gait that is high in traversing performance among the multiple gaits, performs search for a gait switching point on the path found out, and re-searches, in a case where there is a gait switching point, for a path on the cost map of the gait selected by an objective function, by using the gait switching point as a sub goal.

(3) The control apparatus according to (1) or (2) above, in which

the path creation unit searches for a gait switching point by taking a physical property of the robot apparatus into consideration.

(4) The control apparatus according to any one of (1) to (3) above, further including:

an instruction unit that gives an instruction relating to carrying out of a gait including gait switching for the robot, according to the cost maps created by the path creation unit.

(5) The control apparatus according to (4) above, in which

the instruction unit gives to the robot an instruction regarding a transition time period for gait switching.

(6) The control apparatus according to any one of (1) to (5) above, in which

the robot includes legs and wheels,

the cost map creation unit creates a leg cost map for a gait in which the legs are used and a wheel cost map for a gait in which the wheels are used, and

the path creation unit creates the robot path including gait switching between the legs and the wheels.

(7) The control apparatus according to any one of (1) to (6) above, in which

the robot includes legs and allows selection from among multiple gaits that differ in cycle in which the legs are moved,

the cost map creation unit creates a cost map for each of the multiple gaits in which the legs are used, and

the path creation unit creates the robot path including switching between gaits that differ in cycle in which the legs are moved.

(8) The control apparatus according to (7) above, in which

the multiple gaits include at least two of a crawl gait, a trot gait, and a gallop gait.

(9) A control method for a robot, including:

a cost map creation step of creating a cost map for each of gaits of the robot that allows selection from among multiple gaits; and

a path creation step of creating a path including gait switching for the robot by using the cost maps created in the cost map creation step.

(9-1) The control method according to (9) above, in which

the path creation step includes a step of searching for the shortest path by using the cost map of the gait that is high in traversing performance from among the multiple gaits, a step of searching for a gait switching point on the path found out, and a step of re-searching, in a case where there is a gait switching point, for a path on the cost map of the gait selected by an objective function, by using the gait switching point as a sub goal.

(10) A computer program described in a computer-readable form, the computer program causing a computer to function as:

a cost map creation unit that creates a cost map for each of gaits of the robot that allows selection from among multiple gaits; and

a path creation unit that creates a path including gait switching for the robot by using the cost maps created by the cost map creation unit.

### REFERENCE SIGNS LIST

100: Robot apparatus
101: Body unit
102: Visual sensor
103: Joint unit
110A to 110D: Leg unit
111A to 111D: Joint unit
200: Robot apparatus
201: Body unit
202: Visual sensor
203: Joint unit
210R: Right leg unit
210L: Left leg unit
211R, 211L: Joint unit (hip joint)
212R, 212L: Joint unit (knee joint)
213R, 213L: Grounding unit (foot unit)
220R: Right arm unit
220L: Left arm unit
221R, 221L: Joint unit (shoulder joint)
222R, 222L: Joint unit (elbow joint)
223R, 223L: Gripping unit (hand unit)
300: Control system
301: CPU
301A, 301B: Processor core
310: Bus
320: Storage device
321: Memory
322: Display unit
330: Sensor inputting unit
340: Motor inputting/outputting unit
350: Network inputting/outputting unit
400: Robot model
410: Action planning and recognition unit
411: Self-position estimation unit
412: Waypoints inputting unit
413: Cost map creation unit
414: Path creation unit
415: Gait switching instruction unit
420: Control unit

1. A control apparatus for a robot, comprising:
a cost map creation unit that creates a cost map for each of gaits of the robot that allows selection from among multiple gaits; and
a path creation unit that creates a path including gait switching for the robot by using the cost maps created by the cost map creation unit.

2. The control apparatus according to claim 1, wherein
the path creation unit searches for a shortest path by using the cost map of the gait that is high in traversing performance among the multiple gaits, performs search for a gait switching point on the path found out, and re-searches, in a case where there is a gait switching point, for a path on the cost map of the gait selected by an objective function, by using the gait switching point as a sub goal.

3. The control apparatus according to claim 1, wherein
the path creation unit searches for a gait switching point by taking a physical property of the robot apparatus into consideration.

4. The control apparatus according to claim 1, further comprising:
an instruction unit that gives an instruction relating to carrying out of a gait including gait switching for the robot, according to the cost maps created by the path creation unit.

5. The control apparatus according to claim 4, wherein
the instruction unit gives to the robot an instruction regarding a transition time period for gait switching.

6. The control apparatus according to claim 1, wherein
the robot includes legs and wheels,
the cost map creation unit creates a leg cost map for a gait in which the legs are used and a wheel cost map for a gait in which the wheels are used, and
the path creation unit creates the robot path including gait switching between the legs and the wheels.

7. The control apparatus according to claim 1, wherein
the robot includes legs and allows selection from among multiple gaits that differ in cycle in which the legs are moved,
the cost map creation unit creates a cost map for each of the multiple gaits in which the legs are used, and
the path creation unit creates the robot path including switching between gaits that differ in cycle in which the legs are moved.

8. The control apparatus according to claim 7, wherein
the multiple gaits include at least two of a crawl gait, a trot gait, and a gallop gait.

9. A control method for a robot, comprising:
a cost map creation step of creating a cost map for each of gaits of the robot that allows selection from among multiple gaits; and
a path creation step of creating a path including gait switching for the robot by using the cost maps created in the cost map creation step.

10. A computer program described in a computer-readable form, the computer program causing a computer to function as:
a cost map creation unit that creates a cost map for each of gaits of the robot that allows selection from among multiple gaits; and
a path creation unit that creates a path including gait switching for the robot by using the cost maps created by the cost map creation unit.
